(19) United States
(12) Patent Application Publication
(10) Pub. No.: US 2008/0206506 A1
(43) Pub. Date: Aug. 28, 2008

(54) NEW STAIN RESISTANT BARRIER FABRIC

(75) Inventor: Yashavant Vinayak VINOD, Hockessin, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.ar.I., Wilmington, DE (US)

(21) Appl. No.: 12/022,529

(22) Filed: Jan. 30, 2008

Related U.S. Application Data
(60) Provisional application No. 60/903,069, filed on Feb. 23, 2007.

(51) Int. Cl. B32B 5/02; B05D 3/12

(52) U.S. Cl. 428/43; 427/289

(57) ABSTRACT

The instant invention relates to a new liquid repellent and stain resistant barrier fabric comprising a fabric substrate having a face side and an underside with spaced-apart indentations on the underside of the fabric substrate; a primary treat composition covering at least the face side of the fabric substrate; a perforated polymeric latex overlaying the underside of the fabric substrate, wherein the perforations align with the spaced-apart indentations; a polymeric adhesive layer covering the perforated latex; and a polymeric barrier film overlaying the adhesive layer. Such liquid repellent and stain resistant barrier fabrics are suitable in home furnishing and commercial applications.

### CROSS-REFERENCE TO RELATED APPLICATION

This application claims benefit of priority from Provisional Application No. 60/903,069 filed Feb. 23, 2007.

### FIELD OF THE INVENTION

This invention relates to a new liquid repellent and stain resistant barrier fabric, and a method of making the fabric. The barrier fabrics of this invention are stain resistant, easy to clean, liquid impermeable, breathable, and aesthetically pleasing.

### BACKGROUND OF THE INVENTION

A liquid repellent and stain resistant barrier fabric with antimicrobial properties is used in furniture, wall coverings and medical applications as well as other applications wherein a barrier fabric is required. The term “liquid repellent” as used herein means essentially impervious to liquid, especially to aqueous solution. For the purpose of description of the instant invention, the term of “water” is used herein for representing aqueous solution. Liquid repellent barrier fabric refers to the treated fabric that can support a considerable amount of water without water penetration through the fabric.

Liquid repellent barrier fabrics can be made by various processes. Polyvinylchloride (vinyl) coated fabrics have been broadly accepted for water repellency and stain resistance due to relatively easy way for removal of a stain. However, such vinyl coated fabrics are typically stiff to the touch, and thereby lack the desired appearance and feel for use in environments such as restaurants, and nursing homes where pleasing tactile and visual perceptions are considered important.

Surface laminated fabrics have been utilized to enhance the aesthetic characteristic of the fabrics but maintain water repellence of the fabrics. However, due to the generally disjunctive adherence between the laminate film and the fabric itself, the fabric tends to peel, crack, and delaminate after long periods of use. Such laminated fabrics also tend to lack the generally desirable feel of the standard upholstery products.

Liquid repellent barrier fabrics can also be produced by treating the fabrics with stain resist compounds including fluorochemicals; coating the polyurethanes, acrylics or binder resins on the fabrics to improve fabrics abrasion properties; and laminating the treated fabrics with suitable plastic films to impart barrier properties.

Commercially available barrier fabrics with polytetrafluoroethylene (PTFE) membranes such as Goretex® or other polyurethane film laminated fabrics also offer liquid impermeability and breathability. However, there still remains a need for liquid repellent and stain resistant fabrics that are processed with higher efficiency and low cost, and still offer the performance benefits with good fabric aesthetics.

This invention provides such a fabric and a method to make the fabric by incorporating an intermediate perforating step in a conventional manufacturing process of the fabric. The resultant fabric demonstrates high liquid impermeability with increased moisture vapor transmission rate (MVTR) or breathability.

### SUMMARY OF THE INVENTION

This invention relates to a new liquid repellent and stain resistant barrier fabric and a method of making the fabric. More particularly, the invention relates to a liquid repellent and stain resistant barrier fabric comprising a fabric substrate having a face side and an underside with spaced-apart indentations on the underside of the fabric substrate; a primary treat composition covering at least the face side of the fabric substrate; a perforated polymeric latex overlaying the underside of the fabric substrate and the perforations align with the spaced-apart indentations; a polymeric adhesive layer covering the perforated latex; and a polymeric barrier film overlaying the adhesive. Applicant has discovered that by incorporating an intermediate step of perforating fabric after overlaying latex and prior to overlaying the adhesive layer, the resultant fabric showed improved breathability while maintaining high liquid impermeability. Such liquid repellent and stain resistant barrier fabrics are found suitable in home furnishing and commercial applications.

The invention includes a method of making a liquid repellent and stain resistant barrier fabric comprising: a) providing a fabric substrate having a face side and an underside; b) covering at least the face side of the fabric substrate with a primary treatment composition; c) overlaying a polymeric latex in the underside of the fabric substrate; d) perforating the overlaid underside of the fabric substrate; e) covering the perforated underside with a polymeric adhesive layer; and f) overlaying the adhesive layer with a polymeric barrier film.

### DETAILED DESCRIPTION

A fabric substrate suitable for use in this invention has a face side and an underside. The fabric substrate can be formed in any known manner, including weaving, knitting, braiding, nonwoven fabric manufacturing methods, thermo-bonding of fibers, or combination thereof. For purpose of example, the fabrics discussed herein are woven fabrics; however, it is noted that other types of fabrics can be used within the scope of the invention.

Where a woven fabric is used, it is noted that the fabric can be plain woven or can be woven to include a pattern. It is desirable to use a relatively “closed” fabric construction meaning that the fabric does not have large open areas between adjacent fibers and/or yarns which make up the fabric structure. The fabric substrate can be of any weight desired for the particular end use application.

The fabric substrate can be formed of any types of fibers and/or yarns. The fiber materials include but not limit to synthetic materials such as polyester, nylon, rayon, acetate, polypropylene and acrylics, and natural materials such as cotton, wool, linen, ramie, silk, and the like, and blends thereof.

In one embodiment, at least the face side of the fabric substrate is treated and covered with a primary treatment composition. The primary treatment composition includes at lease one of fluorochemical compounds, crosslinking agents, and stain resistant agents. One or more antimicrobial agents can also be added into the primary treatment composition to treat the fabric substrate.

The primary treatment composition can be prepared by mixing any combination of fluorochemical compounds, crosslinking agents, stain resistant agents, antimicrobial agents, and any other ingredients with water until a uniform dispersion is obtained. The fabric substrate can then be topically treated with the primary treatment composition. The primary treatment composition can cover at least the face side or both sides of the fabric substrate. The fabric substrate is then oven dried and cured at elevated temperatures in the range of from about 120° C. to about 180° C.

The fluorochemical compounds used in the instant invention are water insoluble and have one or more fluoro-aliphatic radicals typically one or more perfluoroalkyl radicals.

In one embodiment, fluorocarbonylimino biuret is used in the instant invention and represented by U.S. Pat. No. 4,958,039 (Pechhold), the disclosure of which is incorporated herein by reference. As an example, mention is made of the reaction product of two moles of a mixture of fluoroalcohols of the formula F(CF₂CF₂)ₙCH₂CH₂OH, where n is predominately 5, 4, and 3, with one mole of 1,3,5-tris(6-iso-cyanotohexyl)biuret followed by reaction of residual isocyanate groups with a modifier such as 3-chloro-1,2-propanediol.

In another embodiment, fluoroesters is used in the instant invention and represented by U.S. Pat. No. 3,923,715 (Dettre) and U.S. Pat. No. 4,029,585 (Dettre), the disclosures of which are incorporated herein by references. These patents disclose perfluoroalkyl esters of carboxylic acids of 3 to 30 carbon atoms. An example is citric acid ester of perfluoroalkyl aliphatic alcohols such as a mixture of 2-perfluoroalkyl ethanols containing 8 to 16 carbon atoms.

In yet another embodiment, fluoroester urethane compound is used in the instant invention and is in aforementioned U.S. Pat. No. 4,029,585. An example is the citric acid urethane obtained by reacting the citric acid ester mentioned above with 1-methyl-2,4-diisocyanatobenzene.

In yet another embodiment, fluoropolymer is used in the instant invention and is represented by U.S. Pat. No. 3,645,990 (Raynolds), the disclosure of which is incorporated herein by reference. The patents describe, respectively, fluorinated polymers from acrylic and methylacrylic derived monomers having the structures

CH₂═CH—CO₂CH₂CH₂R_{f}

and

CH₂═C(CH₃)—CO₂CH₂CH₂R_{f}

where R_{f} is a perfluoroalkyl group of about 4 through 14 carbons, and methyl acrylate or ethyl acrylate, optionally with small amounts of other monomers. An example of such a fluoropolymer is the copolymer of the last mentioned formula, wherein R_{f} is a mixture of perfluoroaliphatic radicals of 8 to 16 carbons, with methylacrylate in a 74:26 weight ratio.

Commercially available fluorochemical compounds are used in the instant invention. These compounds include, but are not limited to Zonyl® 8070, Zonyl® 7713, and Zonyl® 7910, available from E.I. DuPont de Nemours, Wilmington, Del.; and Scotchguard™ FC255, and Scotchguard™ FC214-230, available from 3M, St. Paul, Minn.

Crosslinking agents suitable for use in the primary treatment composition include resins which are formed covalent bonds between polymeric molecules of the fabrics. The suitable crosslinking agents are the compounds that may be functionalized by hydroxyl groups, carboxyl groups, carbonyl groups, or amine groups. As known to those skills in the textile industry, the efficiency of the crosslinking process can often be enhanced by using a catalyst. For example, ionic salts may be added to the crosslinking agent to promote crosslinking when the applied composition's temperature is raised above a certain critical threshold.

In one embodiment, the crosslinking agent is a non-formaldehyde resin. The non-formaldehyde resins include but are not limited to an emulsified or water-soluble multifunctional polycarbodiimide, polycarboxylic acid, dimethyl dihydroxyethlene urea, glyoxal, diisocyanate, diepoxide, and dihaloalkane. Typical polycarboxylic acids include but are not limited to butanetetracarboxylic acid, polymaleic acid, and citric acid. Typical glyoxal is dimethylureaglyoxal. One example of commercial available polycarbodiimide is Carbodilite E-02 manufactured by Advanced Polymer, Inc. at Carlstadt, N.J.

The stain resistant agents applied in the instant invention include at least one of the water-soluble or water-dispersible polymeric sulfonated phenol-formaldehyde condensation products, mixtures containing any of hydrolyzed maleic anhydride/α-olefin copolymers, hydrolyzed maleic anhydride/styrene copolymers, polymethacrylic acid polymers, polymethacrylic acid copolymers, or mixtures of the above compositions.

The polymeric sulfonated phenol-formaldehyde condensation products are any of those described in the prior art as being useful as dye-resist agents or dye-fixing agents. Particular examples include but are not limited to diphenolic sulfones, and sulfonated naphthalene condensates. A particular sulfonated phenol-formaldehyde suitable used in the instant invention contains a condensation product of 4,4′-dihydroxy diphenolsulfone, and formaldehyde. Other sulfonated phenol-formaldehyde condensation products that may be used in the instant invention include those disclosed in U.S. Pat. Nos. 5,501,591; 5,592,940; 4,680,212; 4,822,373; 4,937,123; 5,447,755; 5,654,068; 5,708,087; 5,707,708; 5,074,883; 4,940,757; 5,061,763; and 5,629,376, which are all incorporated herein by references in their entireties.

A variety of linear and branched chain alpha-olefins (α-olefin) can be used to form a copolymer with maleic anhydride. Particularly useful alpha-olefins are 1-alkenes, containing 4 to 12 carbon atoms, preferably C₄₋₁₀, such as isobutylene, 1-butene, 1-hexene, 1-octene, 1-decene, and dodecene. Hydrolyzed maleic anhydride/styrene copolymers are also used in the instant invention.

A part of the maleic anhydride in the copolymer can be replaced by acrylic acid, methacrylic acid, itaconic acid, vinyl sulfonic acid, vinyl phosphonic acid, styrene sulfonic acid, alkyl(C₁₋₄) acrylate, alkyl(C₁₋₄) methacrylate, vinyl acetate, vinyl chloride, vinylidine chloride, vinyl sulfides, N-vinyl pyrrrolidone, acrylonitrile, acrylamide, and mixtures thereof. In another embodiment, a part of the maleic anhydride can be replaced by maleimide, N-alkyl (C₁₋₄) maleimides, N-phenylmaleimide, fumaric acid, crotonic acid, cinnamic acid, alkyl (C₁₋₁₈) esters of the foregoing acids, cycloalkyl (C₃₋₈) esters of the foregoing acids, sulfated castor oil, or the like.

The maleic anhydride copolymers useful in the instant invention can be prepared according to the methods well-known in the art. The maleic anhydride polymers thus obtained can be hydrolyzed to free acids or their salts by reaction with water or alkali, or they can also be reacted with C₁₋₄ alkyl alcohol to provide polymeric alpha-olefin/maleic acid monoesters. Generally, the hydrolyzed maleic anhydride polymer, or the monoester polymer, should be sufficiently water-soluble that a uniform application to a fibrous surface can be achieved at an appropriate acidity. However, applications using water dispersions of the polymer mixed with a suitable surfactant may be used to impart stain-resistance.

Preparation of maleic anhydride/alpha-olefin polymers is also described in Reissue U.S. Pat. No. 28,475 (Blecke) and in EP 306992 (Billman) the disclosures of which are specifically incorporated by reference. These references contain further teaching of techniques for the preparation of such polymers.

The methacrylic polymer used in the instant invention includes the polymethacrylic acid homopolymer as well as polymers formed from methacrylic acid and one or more other monomers. The monomers useful for copolymerization with the methacrylic acid are monomers having ethylenic unsaturation. Such monomers include, for example, monocarboxylic acids, polycarboxylic acids, and anhydrides; substituted and unsubstituted esters and amides of carboxylic acids and anhydrides; nitriles; vinyl monomers; vinylidene monomers; mono-olefinic and polyolefinic monomers; and heterocyclic monomers.

Representatives of the specific monomers include but are not limited to acrylic acid, itaconic acid, citraconic acid, aconitic acid, maleic acid, maleic anhydride, fumaric acid, crotonic acid, cinnamic acid, oleic acid, palmitic acid, vinyl sulfonic acid, vinyl phosphonic acid, alkyl or cycloalkyl esters of the foregoing acids, alkyl or cycloalkyl having 1 to 18 carbon atoms such as, for example, ethyl, butyl, 2-ethylhexyl, octadecyl, 2-sulfoethyl, acetoxyethyl, cyanoethyl, hydroxyethyl and hydroxypropyl acrylates and methacrylates, and amides of the foregoing acids, such as, for example, acrylamide, methyacrylamide, and 1,1-dimethylsulfoethylacrylamide, acrylonitrile, methacrylonitrile, styrene, α-methylstyrene, p-hydroxystyrene, chlorostyrene, sulfostyrene, vinyl alcohol, N-vinyl pyrrolidone, vinyl acetate, vinyl chloride, vinyl ethers, vinyl sulfides, vinyl toluene, butadiene, isoprene, chloroprene, ethylene, isobutylene, vinylidene chloride, sulfated castor oil, sulfated sperm oil, sulfated soybean oil, and sulfonated dehydrated castor oil. Particularly useful monomers include, for example, alkyl acrylates having 1-4 carbon atoms, itaconic acid, sodium sulfostyrene, and sulfated castor oil. The mixtures of the monomers, such as, for example, sodium sulfostyrene and styrene, and sulfated castor oil and acrylic acid, can be copolymerized with the methacrylic acid.

The methacrylic polymers suitable for the purposes of the instant invention relates to those prepared by polymerizing methacrylic acid, with or without at least one other ethylenically unsaturated monomer described above, in the presence of sulfonated hydroxy-aromatic compound/formaldehyde condensation resins. Those homopolymers and copolymers and their preparation are described in the U.S. Pat. No. 4,940,757 (Moss), the contents of which are incorporated herein by reference.

An antimicrobial agent is used in the instant invention. “Antimicrobial agent” is meant any substance or combination of substances that kills or prevents the growth of a microorganism. The agents include antibiotics, antifungal, antiviral, and antialgal agents. Suitable antimicrobials also include fungicides. The examples include but are not limited to trialkyltin compounds such as tributyl tin oxide and tributyl tin acetate, copper compounds such as copper-8-quinilinolate, metal complexes of dehydroabietyl amine and 8-hydroxyquinium-2-ehtylhexoate, copper naphthenate, copper oleate, and organosilicon quaternary ammonium compounds.

The underside of the treated and dried fabric substrate is coated with a layer of polymeric latex after treated by the preliminary treatment compositions. The coating may be applied to the fabric substrate by known techniques such as extrusion, spraying, foaming, dipping, knife coating, or transfer coating. The polymeric latex coating may be subsequently cued by thermal heating, UV light, or fusion.

Examples of the latex used in the instant invention include but are not limited to polyurethane, acrylic polymer and copolymer, rubbery butadiene-styrene polymer, polyvinyl acetate, ethylene vinyl acetate copolymer, neoprene, polyisoethylene, nitrile rubber, polybutadiene, ethylene propylene copolymer, and polyvinyl chloride.

In one embodiment, acrylic latex is used. The acrylic latex comprises a dispersion of polymers and/or copolymers of acrylic or acylate functional monomers, optionally copolymerized with other ethylenically unsaturated monomers.

The coated underside of the fabric substrate with polymeric latex is perforated by using any of the known commercial perforating techniques, including thermal, mechanical, and hydraulic methods. Examples of such techniques include but are not limited to needle-punching, calendaring or embossing with a fine engraved roll, or a roll covered with fine pins. The depth of penetration, the needle size, stroke density can be varied to achieve different levels of perforation using needle-punching technology. Other perforating or micro perforating techniques such as ultrasonic or laser perforation can also be used.

The perforation can be conducted so that only the coated underside is perforated with minimal penetration of the face side of the fabric substrate. As a result, the space-apart indentations are formed on the underside of the substrate, and align with the perforation of the latex layer.

A polymeric barrier film is bonded to the perforated latex with a suitable adhesive. The polymeric barrier film can be any film formed by any fabrication technique known in the art. It can be extruded or cast film. The polymeric film may be made of any curable or crosslinkable polymer, copolymer, blend, and the like, of polymeric material. Such polymeric materials include but are not limited to thermosetting and thermoplastic materials such as polyvinyl chloride, polyesters, polyamides, nylon, polysulfones, polyethylene, polypropylene, polychloroprene (neoprene), polystyrene, polymethylstyrene, polyethylene terephthalate, polyisoprene, polyvinyl acetate, polyvinylidene chloride, silicone resins, styrene-acrylonitrile copolymer resins, aliphatic and aromatic urethanes, and/or acrylates and their oligomers, polymethyacrylates, isobornyl acrylate, polymethylmethacrylates, diol diacrylates, styrene-butadiene copolymers, polycarbonates, polycaprolactams, natural rubber latex, and blends thereof.

In one embodiment, the materials from the polymeric film include a resilient perfluoroalkyl material or resilient elastomeric material such as butylene/poly(alkylene ether) phthalate copolymer material available from E.I. du Pont Nemours and Company, Wilmington, Del., under the trademark “HYTREL®”. Other resilient elastomeric materials include vulcanized silicone rubber, silicone polymer, polyurethanes, polyether/polyester, polyether/amides, polyvinyl alcohol, and copolymers and blends thereof.

Any adhesive known in the art can be used to laminate the polymeric film to the perforated underside of the fabric substrate. The adhesive may be one that is applied in a solid form, as in the form of solid powder, solid film or solid adhesive web. Particularly, non-woven adhesive fibrous web can be used. The adhesive should have a melting temperature that is lower than the melting temperature of the material used to form the polymeric film such that the film is bond thermally to the underside of the fabric substrate.

In one embodiment, a polymeric film can be adhered to the perforated underside of the fabric substrate by employing a thin suitable intermediate hot-melt adhesive layer between the polymeric film and the fabric substrate. The intermediate hot-melt adhesive layer can be laminated between the fabric substrate and the polymeric film by any known technique. The polymeric film is generally supplied from a roll of performed polymeric film and a thin layer of hot-melt adhesive is melted between the fabric substrate and the polymeric film. The hot-melt adhesive is applied usually in an amount in the range of from about 0.25 to about 3 oz/yd² (9 to 100 g/m²) depending upon the adhesive although less or more adhesive could be used, if desired. The adhesive, after being heated, is then allowed to cool at room temperature to secure the polymeric film to the fabric.

Liquid adhesives can also be used. Suitable liquid adhesives for use are well known in the art. Examples include but are not limited to plastisol, epoxy, acrylic, organosol, and urethane adhesives. The liquid adhesives can be applied to the polymeric film by known coating techniques such as gravure cylinder, knife, roller, reverse roller, anilox roller, and laminated under heat between the film and the fabric.

The liquid impermeability of the liquid repellent and stain resistant barrier fabric was measured by using a hydrostatic testing machine and following an AATCC 127 test method. The fabric breathability was tested by using an ASTM-E96 method and was expressed in terms of moisture vapor transmission rate or MVTR in gms/mt²/24 hours.

The liquid impermeability of the liquid repellent and stain resistant barrier fabric was also tested by using “Staining Test” Procedure. A staining solution of forty five (45) grams of a cherry flavored, sugar sweetened, Kool-Aid brand powder drink mix is mixed in five-hundred milliliters (500 ml) of water. The solution is allowed to reach room temperature (24±3° C.) before using. A white absorbent paper towel or blotter paper is placed beneath the bottom layer of a test sample of fabric approximately six inches (6 in) square [approximately fifteen centimeters (15 cm) square]. Twenty milliliters (20 ml) of the staining solution are poured onto the top surface of the test sample of the fabric through a one and one-half inch (3.8 cm) diameter cylinder from a height of about three centimeters (3 cm) to create a circular stain on the top surface of the fabric. The cylinder is removed and the staining solution was mechanically worked onto the fabric, e.g., by hand, to obtain uniform staining. The fabric is allowed to stay undisturbed for twenty-four (24) hours.

The invention will be described in greater details in conjunction with the following, non-limiting example.

### EXAMPLE

Commercial upholstery fabrics of 100% polyester, and 49% polyester/51% cotton of various weights were first treated with a formulation of stain resist fluorochemical, Zonyl® 8070, and a cross-linking polycarbodiimide resin, Carbodilite E-02 from Advanced Polymer, Inc., Carlstadt, N.J. in a pad bath and then dried in an oven. The fabrics were then backcoated with a polyurethane latex and water resistant formulation (˜1.0 oz/yd²), and then dried in an oven. About ½ of these fabrics were

perforated on a needle-punching machine using needles (Foster F20.6-20-2.6B—size 15×18×38×3 RBA) with 0.5 mm needle depth of penetration into the underside of the coated fabric. It was estimated that the underside of the coated fabric had about 300 perforations per square inch at 1164 strokes/minute and at 6.5 meters per minute. The coated fabrics with perforated and non-perforated treatment were laminated using two different types of waterproof, breathable films. They were 15 and 20 micron thickness DuPont Active Layer® (DAL) film, and 25 micron polyurethane (PU) film. The DuPont Active Layer® films were obtained from E.I. DuPont Co., Wilmington, Del. and were laminated using 0.6 oz/yd², low melt polyester adhesive web from Spunfab Adhesive fabrics, Cuyahoga Falls, Ohio. The PU film of ST-3256 PU was obtained from Stevens Urethane, East Hampton, Pa., and was laminated using low melt polyester adhesive web. The lamination was conducted at a temperature of about 166° C. and 6 yards per minute. The finished fabrics were then tested for water imperviousness using hydrostatic testing machine Textest FX 3000 Hydrotester III. The breathability was measured by using ASTM—E96 method (inverted cup method). The results are listed in Table 1. The finished fabrics were also tested using Staining Test as described previously. The test results indicated that all the fabrics samples did not show any stains after twenty-four (24) hours.

TABLE1
Barrier Fabrics - Test Data

| | | | | | | Hydrostatic | |
|---|---|---|---|---|---|---|---|
| | | | Fabric wt | | Perforating | Reading | MVTR |
| No. | Fabric Type | Ends × Picks | (oz/yd²) | Film type | Treatment | (mbar) | (gms/mt²/24 h) |
| 1 | 100% | 140 × 140 | 6.47 | 20 micron | No | 200 | 3,991 |
| | Polyester | | | DAL | | | |
| 2 | 100% | 140 × 140 | 6.47 | 20 micron | Yes | 219 | 5,003 |
| | Polyester | | | DAL | | | |
| 3 | 49% PET | 140 × 38 | 6.64 | 20 micron | No | 165 | 4,304 |
| | and 51% | | | DAL | | | |
| | cotton | | | | | | |
| 4 | 49% PET | 140 × 38 | 6.64 | 20 micron | Yes | 201 | 4,593 |
| | and 51% | | | DAL | | | |
| | cotton | | | | | | |
| 5 | 100% | 140 × 140 | 5.37 | 25 micron | No | 181 | 84 |
| | Polyester | | | PU | | | |
| 6 | 100% | 140 × 140 | 5.37 | 25 micron | Yes | 280 | 165 |
| | Polyester | | | PU | | | |
| 7 | 100% | 140 × 48 | 5.37 | 25 micron | No | 220 | 127 |
| | Polyester | | | PU | | | |
| 8 | 100% | 140 × 48 | 5.37 | 25 micron | Yes | 329 | 150 |
| | Polyester | | | PU | | | |
| 9 | 49% PET | 140 × 38 | 6.64 | 15 micron | No | 51 | 4,210 |
| | and 51% | | | DAL | | | |
| | cotton | | | | | | |
| 10 | 49% PET | 140 × 38 | 6.64 | 15 micron | Yes | 165 | 4,597 |
| | and 51% | | | DAL | | | |
| | cotton | | | | | | |

The data shows that the perforation after back coating and prior to film lamination step increases the water imperviousness as measured by the hydrostatic readings and also improves breathability as measured by MVTR.

What is claimed is:

1. A barrier fabric comprising:
a fabric substrate having a face side and an underside with spaced-apart indentations on the underside of said fabric substrate;
a primary treatment composition covering at least the face side of said fabric substrate;
a perforated polymeric latex overlaying the underside of said fabric substrate,
wherein said perforations align with said spaced-apart indentations;
a polymeric adhesive layer covering said perforated latex; and
a polymeric barrier film overlying said adhesive layer.

2. The barrier fabric of claim 1, wherein the primary treatment composition comprises a fluorochemical compound and a crosslinkable resin.

3. The barrier fabric of claim 2, wherein the primary treatment composition further comprises a stain resistant agent.

4. The barrier fabric of claim 2 or claim 3, wherein the primary treatment composition further comprises an antimicrobial agent.

5. The barrier fabric of claim 1, wherein the polymeric latex comprises a polyurethane latex.

6. The barrier fabric of claim 1, wherein the polymeric latex comprises an acrylic latex.

7. The barrier fabric of claim 1, wherein the polymeric adhesive layer is a polyester copolymer adhesive layer.

8. The barrier fabric of claim 1, wherein the polymeric barrier film comprises a polyurethane film.

9. The barrier fabric of claim 1, wherein the polymeric barrier film comprises a polyester polyurethane film.

10. The barrier fabric of claim 1, wherein the polymeric barrier film comprises a polyether polyurethane film.

11. The barrier fabric of claim 2, wherein the fluorochemical comprises at least one of a fluorocarbonylimino biuret, a fluroester, a fluoroester carbamate, and a fluoropolymer, and mixtures thereof.

12. The barrier fabric of claim 2, wherein the crosslinkable resin is a non-formaldehyde resin.

13. The barrier fabric of claim 3, wherein the stain resistant agent comprises at least one of a sulfonated phenol-aldehyde condensation product, a sulfonated naphthol-aldehyde condensation product, a polymethacrylic acid polymer, an acrylic acid polymer, a copolymers of acrylic acid or methacrylic acid with ethylenically unsaturated comonomers, and a hydrolyzed maleic anhydride copolymer with an ethylenically unsaturated comonomer.

14. A method for preparation of a barrier fabric, the method comprising:
a) providing a fabric substrate having a face side and an underside;
b) covering at least the face side of said fabric with a primary treatment composition;
c) overlaying a polymeric latex in the underside of said fabric substrate;
d) perforating the overlaid underside of said fabric substrate;
e) covering the perforated underside with a polymeric adhesive layer; and
f) overlaying the adhesive layer with a polymeric film.

15. The method of claim 14, wherein the primary treatment composition comprises a fluorochemical compound and a crosslinkable resin.

16. The method of claim 14, wherein the primary treatment composition further comprises a stain resistant agent.

17. The method of claim 15 or claim 16, wherein the primary treatment composition further comprises an antimicrobial agent.

19. The method of claim 14, wherein the polymeric latex comprises a polyurethane latex.

20. The method of claim 14, wherein the polymeric latex comprises an acrylic latex.

21. The method of claim 14, wherein the polymeric barrier film comprises a polyurethane film.

22. The method of claim 14, wherein the polymeric barrier film comprises a polyester polyurethane film

23. The method of claim 14, wherein the polymeric barrier film comprises a polyether polyurethane film.

24. The method of claim 14, wherein the fluorochemical comprises at least one of a fluorocarbobyllimino biuret, a fluoroester, a fluoroester carbmate, and a fluoropolymer, and mixtures thereof.

25. The method of claim 11, wherein the crosslinkable resin is a non-formaldehyde resin.

26. The method of claim 14, wherein wherein the stain resistant agent comprises at least one of a sulfonated phenol-aldehyde condensation product, a sulfonated naphthol-aldehyde condensation product, a polymethacrylic acid polymer, an acrylic acid polymer, a copolymers of acrylic acid or methacrylic acid with ethylenically unsaturated comonomers, and a hydrolyzed maleic anhydride copolymer with an ethylenically unsaturated comonomer.
